(19) United States
(12) Patent Application Publication
(10) Pub. No.: US 2012/0194484 A1
(43) Pub. Date: Aug. 2, 2012

(54) Stylus

(75) Inventor: Donald Lehman, Chicago, IL (US)

(73) Assignee: MORE/REAL LLC, Chicago, IL (US)

(21) Appl. No.: 13/359,093

(22) Filed: Jan. 26, 2012

Related U.S. Application Data
(60) Provisional application No. 61/437,215, filed on Jan. 28, 2011.
(60) Provisional application No. 61/451,883, filed on Mar. 11, 2011.
(60) Provisional application No. 61/526,837, filed on Aug. 24, 2011.

(51) Int. Cl. G06F 3/033

(52) U.S. Cl. 345/179

(57) ABSTRACT

A stylus is disclosed having a tip and a body. The stylus may be configured to attach to a writing utensil. The stylus may be a capacitive stylus for use with a capacitive touch screen. The tip may be removeably attached to the body.

### CROSS REFERENCE TO RELATED APPLICATIONS

The present application claims priority to provisional application Ser. Nos. 61/437,215 filed on Jan. 28, 2011, entitled “A capacitive touch screen stylus that caps a pen or a marker,” 61/451,883 filed on March 11, 2011, entitled “Replaceable Tip for a Stylus, and 61/526,837 filed on Aug. 24, 2011, entitled “Tip for a Capacitive Stylus.” The contents of each of which are incorporated by reference herein in their entirety.

### BACKGROUND

A stylus can be used with many electronic devices to accurately navigate through menus, send messages, etc. A stylus is generally pointed at one end and is made to fit in the grip of a hand. Styluses can be found in different styles. Generally, a once stylus is damaged or worn, it must be thrown away. Capacitive stylus tips in general tend to feel bulky and spongy.

### BRIEF DESCRIPTION OF THE FIGURES

FIG. 1 is a perspective view of an example stylus cap and writing utensil of the present application;

FIG. 2A is a front view of an example stylus of the present application attached to a writing utensil;

FIG. 2B is a front view of the stylus of FIG. 1 with the tip removed;

FIG. 3 shows the stylus of the present application in use;

FIG. 4 is a cross-sectional view of the stylus shown in FIG. 1;

FIG. 5 is a front view of example fastening mechanism that may be used with the stylus shown in FIG. 1;

FIG. 6 is a front view of example tips that may be used with the stylus shown in FIG. 1;

FIG. 7 is a cross-sectional view of a prior art stylus tip in the rest position;

FIG. 8 is a cross-sectional view of a prior art stylus tip in the flexed position;

FIG. 9 is cross-sectional view of the stylus tip of the present application in the rest position; and

FIG. 10 is cross-sectional view of the stylus tip of the present application in the flexed position.

### SUMMARY

In one embodiment, a capacitive stylus is disclosed. The capacitive stylus includes a tip and a body attached to the tip. The body is configured to attach to a writing utensil.

In another embodiment, a stylus cap is disclosed. The stylus cap includes a tip and a body removeably attached to the tip. The body is configured to fit over a writing utensil. The tip includes at least two flex points that flex when the tip is pressed against a surface.

In yet another embodiment, a utensil for use on a capacitive touch screen is disclosed. The utensil includes a writing utensil in combination with a stylus cap configured to attach to the writing utensil.

### DETAILED DESCRIPTION

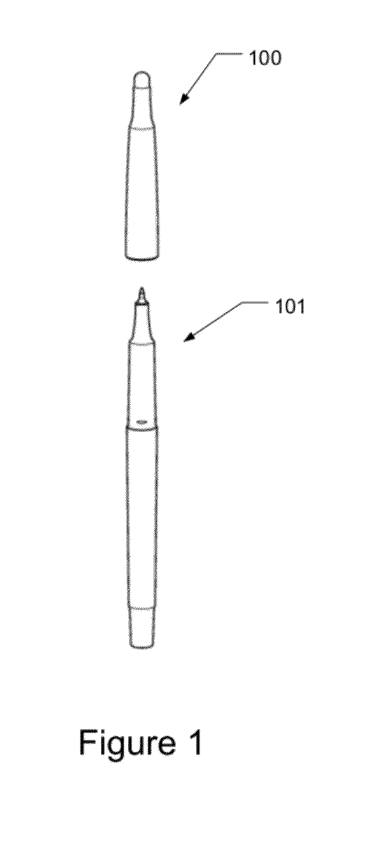

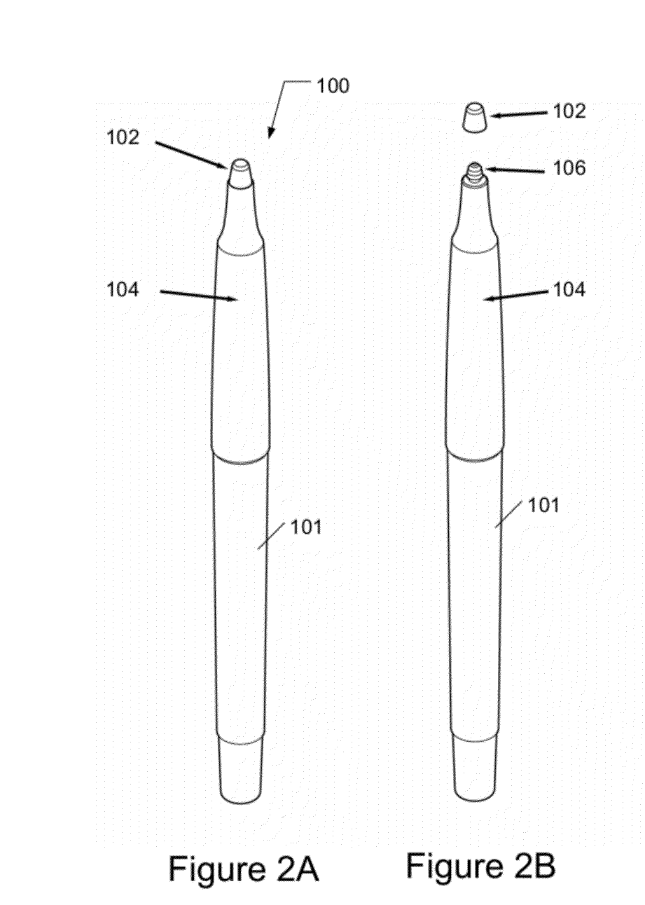

FIG. 1 shows an example stylus 100 of the present application. In one example, the stylus 100 may be in the form of a cap that may be placed on a writing utensil 101. In another embodiment, the stylus 100 may attach to a writing utensil in another manner. As shown in FIGS. 2A and 2B, the stylus 100 may include a tip 102 and a body 104. The stylus 100 may be a capacitive stylus, for example, which is a stylus for use with a capacitive touch screen. Capacitive touch screens monitor changes in electrical current. When a finger or a stylus makes contact with the screen, the screen changes the state that the device is monitoring. Capacitive touch screens use a layer of capacitive material to hold an electrical charge; touching the screen changes the amount of charge at a specific point of contact.

Alternatively, the stylus 100 may be any type of stylus that is compatible for use with a touch screen device such as the iPad® or Android device, for example. The tip 102 may be removable and replaceable so a user can use the same body 104 with a different tip, as shown in FIG. 2B. The replaceable tip is useful in the event that the tip wears out from use, becomes damaged, or if the user prefers a different size or shape tip. Alternatively, the tip 102 may be permanently attached to the body 104.

The tip 102 may be made of a conductive material that continues a circuit from a user's hand 120, to the body 104, to a capacitive touch screen 130. For example, the tip 102 may be made from a flexible material such as rubber, plastic, fabric, felt, foam, metal spring, as well as others. The tip 102 may also be made of a non-flexible material such as metal or hard plastic, and may also have internal features. The material may aid in the having the stylus feel like using a traditional writing tool. For example, some materials may allow the tip to glide on the screen like a pencil, where as other materials may feel stickier to replicate the feel of a crayon.

In some embodiments, the tip 102 may include a coating. The coating may have properties that include conductive, lubricating, friction reducing, wear resistance, temperature resistance, as well as others. Alternatively, coatings may be applied to the screen of the device to enhance the use of the tip.

The tip 102 may be in the shape of a dome, a cone, a chisel, or a ball, for example, and may be fat, wide, thin, pointed, or any other shape and size that is used in writing or drawing devices.

The tip 102 may further include textures to facilitate movement of the tip over the capacitive touch screen 130 in a user controllable fashion. Example textures may include satin, rough, smooth, polished, and ribbed, for example, to allow for the stylus to glide over the touch screen similar to the way a writing device glides over paper. The tip 102 may further be designed and/or made of materials that protect capacitive touch screens from scratching or damage.

The body 104 may be made out of any material that has conductive properties to complete the circuit from the user's hand 120 to the capacitive touch screen 130. For example, metals, plastics with conductive filler, materials inlaid with a conductive material, or any material that is covered with a conductive material may be used. The body 104 may be shaped to be secured in place onto a writing device, such as a pen, pencil, marker, etc. The body 104 may be capped onto the device, wrapped around the device, clipped onto the device, or adhered to the device via glue, tape, Velcro®. The body 104 may also be shaped to fit ergonomically in the user's hand. In some embodiments, the body 104 may include a finish, such as a smooth finish, satin finish, polished finish, brushed finished, or grip points for the user. In other examples, the body 104 may be painted or anodized.

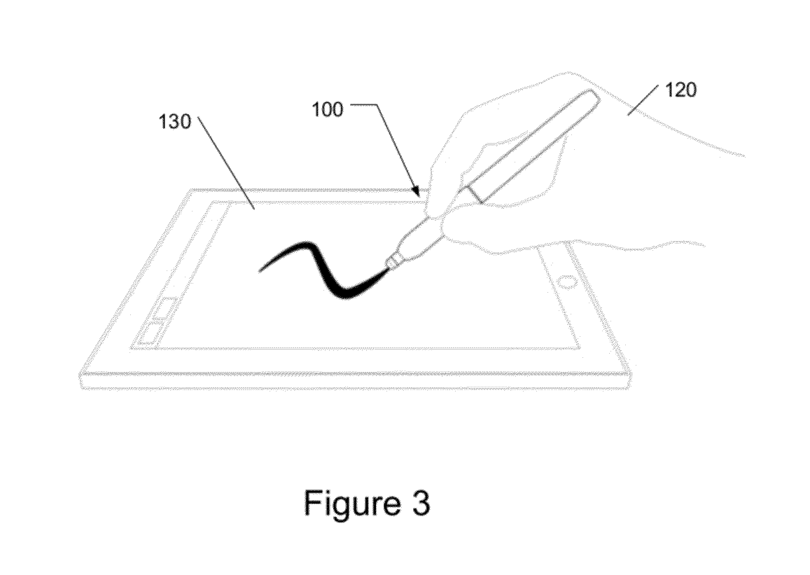

The body 104 and tip 102 allow the stylus to interact with a graphical user interface of a capacitive touch screen device, as shown in FIG. 3. When the stylus 100 contacts the touch screen 130, electrical charge is transferred between the touch screen 130, the stylus 100, and the user's hand 120. The stylus 100 functions in a similar manner as a traditional writing device, but instead of writing on paper or other media, the writing or drawing is performed on a capacitive touch screen.

In one embodiment, the body 104 may include ergonomic grip points to facilitate an ergonomic fit in the user's hand.

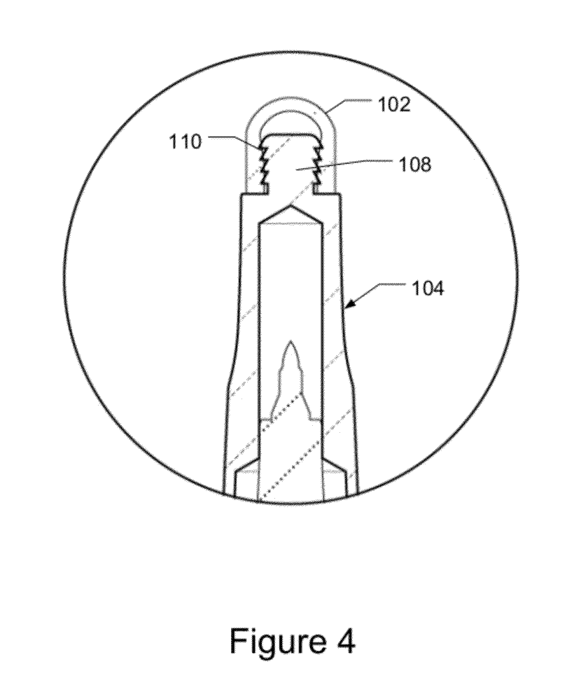

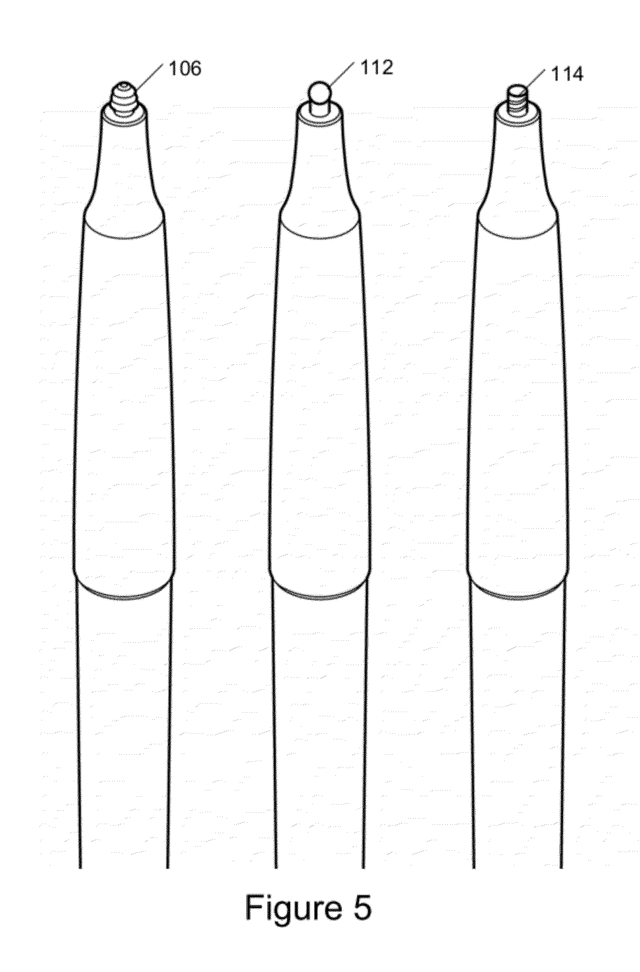

The tip 102 can be attached to the body 104 in numerous ways including, for example, press fit, threaded screw, clip, magnets, suction cup, adhesive, and over molded. In one embodiment, the stylus body 104 has a fastening mechanism 106 to secure the tip 102 to the body 104. As shown in FIG. 4, the fastening mechanism 106 may include, for example, a male portion 108 secured to the stylus body 104 and a female portion 110 associated with the tip 102. The male 108 and female 110 portions may have complimentary shapes so they may fasten securely to each other. The male portion 108 may fit within the female portion 110. In one example, shown in FIG. 4, the male 108 and female 110 portions may have complimentary arrow head shapes. In alternative embodiments, the male and female portions 108, 110 may have various other complimentary shapes, such as a ball and socket 112, or a threaded design 114, as shown in FIG. 5. Other possibilities exist as well.

It should be understood that any alternate fastening mechanism may be used to secure the tip 102 onto the body 104, such as, for example, a force fit, a screw, a snap fit, glue or adhesive, Velcro®, a magnet, tape, or any other fastening mechanism.

The fastening mechanism 106 may also be shaped so as to help with the writing experience. For example, the shape may facilitate giving the user a sense of a finer point than what a capacitive touch screen generally allows.

The tip 102 may be made from a material onto which the fastening mechanism 106 may be secured. For example, the tip 102 may be made of a flexible material such as rubber, plastic, fabric, felt, foam, metal spring, as well as others which would allow the female portion 110 of the tip 102 to grip the male portion 108 of the body 104. The tip 102 may also be made of a non-flexible material such as metal or hard plastic which would require internal features to allow the female portion 110 of the tip 102 to have a better grip on the male portion 108 of the body 104. The flexible materials may also have internal features.

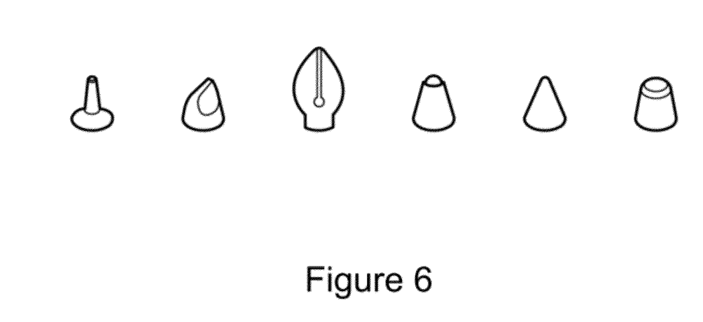

The tip 102 may be attached and removed by the user. Replacement tips may come in different shapes that replicate familiar writing tool shapes or new shapes that take advantage of a multi-touch display. Example shapes include finepoint, chisel, fountain pen tip, roller ball, pencil tip, and felt tip, which are shown in FIG. 6. Other possibilities exist as well.

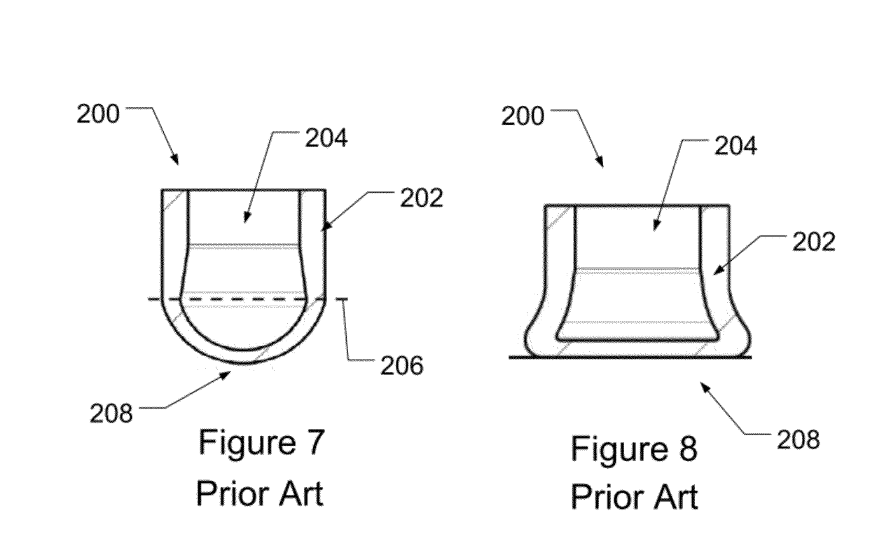

As shown in FIG. 7, typical stylus tips 200, which may be capacitive styluses, include an outer portion 202 and a hollow inner portion 204. The tip 200 includes two aligned flex point centers 206. The outer portion 202 of the tip bends at both of the flex point centers 206 together when the tip 200 is pressed against a surface. Because the flex point centers 206 are aligned like a concentric dome, typical capacitive stylus tips tend to flex more. Thus, when pressed against a surface, a large portion of an end 208 of the tip 200 flattens against the surface, as shown in FIG. 8, which increases the amount of surface area of the tip touching the surface. This large surface area causes the tip to feel bulky and spongy against the surface, instead of precise and pointed, like a regular pen or marker.

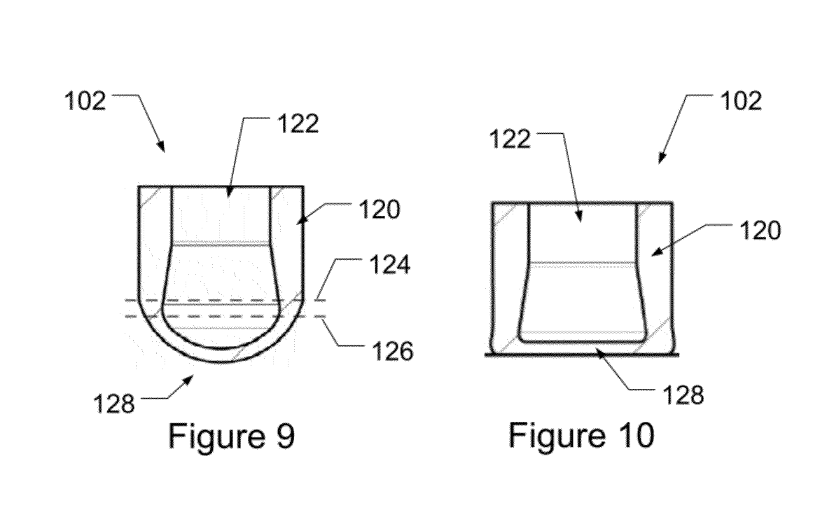

Referring to FIG. 9, the tip 102 of the present application may include an outer portion 120 and a hollow inner portion 122. The width of the outer portion 120 may be larger than that of prior art tips, and the width of the hollow inner portion 122 may be smaller than that of prior art tips. These dimensions create a firmer base for an end 128 of the tip 102 to be depressed against, which enables the stylus tip 102 to feel less spongy and more precise to a user.

The tip 102 further includes two separate flex point centers 124 and 126. The outer portion 120 of the tip 102 bends at both flex point centers 124 and 126 when the tip is pressed against a surface. The presence of the two separate flex point centers allows a smaller surface area of the end 128 of the tip 102 to flatten when pressed against the surface, as shown in FIG. 10, thereby creating a less spongy feeling to a user. In addition, the male portion of the fastening mechanism 108 may be shaped to help facilitate the feel of precision.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A capacitive stylus comprising:
a tip; and
a body attached to the tip, the body being configured to attach to a writing utensil.

2. The capacitive stylus of claim 1 wherein the tip is removable from the body.

3. The capacitive stylus of claim 1 wherein the body includes a fastening mechanism to secure the tip to the body.

4. The capacitive stylus of claim 1 wherein the tip is made of a flexible material.

5. The capacitive stylus of claim 1 wherein the body is capped onto the writing utensil.

6. The capacitive stylus of claim 1 wherein the tip includes at least two flex points that flex when the tip is pressed against a surface.

7. A stylus cap comprising:
a tip; and
a body removeably attached to the tip, the body being configured to fit over a writing utensil;
wherein the tip includes at least two flex points that flex when the tip is pressed against a surface.

8. The stylus cap of claim 7 wherein the body includes a fastening mechanism to secure the tip to the body.

9. The stylus cap of claim 7 wherein the tip is made of a flexible material.

10. The stylus cap of claim 7 wherein the stylus cap is a capacitive stylus cap.

11. A utensil for use on a capacitive touch screen comprising:
a writing utensil; and
a stylus cap configured to attach to the writing utensil.

12. The utensil of claim 11 wherein the stylus cap includes a tip attached to a body, the body being configured to attach to the writing utensil.

13. The utensil of claim 11 wherein the tip is removable from the body.

14. The utensil of claim 11 wherein the body includes a fastening mechanism to secure the tip to the body.

15. The utensil of claim 11 wherein the tip is made of a flexible material.

16. The utensil of claim 11 wherein the body is capped onto the writing utensil.

17. The utensil of claim 11 the tip includes at least two flex points that flex when the tip is pressed against a surface.

18. The utensil of claim 11 wherein when the stylus contacts the capacitive touch screen, electrical charge is transferred between the touch screen, the stylus cap, and a user's hand.
